(19) United States
(12) Patent Application Publication
(10) Pub. No.: US 2025/0191524 A1
(43) Pub. Date: Jun. 12, 2025

(54) DRIVING METHOD OF DISPLAY DEVICE

(71) Applicant: AUO Corporation, Hsinchu City (TW)

(72) Inventors: Yu-Wei CHANG, Hsinchu City (TW); Yu-Shian LIN, Hsinchu City (TW); Yi-Fu OU, Hsinchu City (TW)

(21) Appl. No.: 18/906,198

(22) Filed: Oct. 4, 2024

(30) Foreign Application Priority Data
Dec. 6, 2023 (TW) 112147532

(51) Int. Cl. G09G 3/32; G09G 3/20

(52) U.S. Cl. CPC G09G 3/32; G09G 3/2092; G09G 2300/0842; G09G 2300/0861; G09G 2310/08; G09G 2320/0233; G09G 2320/0247

(57) ABSTRACT

A driving method of a display device is used for driving pixel circuits in a plurality of columns, and each pixel circuit has light emitting element. The driving method includes performing a plurality of driving sequences during a frame time to sequentially drive the pixel circuits in each column, in which performing each driving sequence includes inputting data pulse signal to corresponding pixel circuits for writing data information; and inputting light emitting control pulse signal to corresponding pixel circuits. The light emitting control pulse signal includes at least one light emitting control pulse during the frame time. The data pulse signal and the light emitting control pulse signal of each driving sequence are alternately inputted to the pixel circuits in the corresponding columns, so that the pixel circuits in each column do not receive the data pulse signal and the light emitting control pulse at the same time.

### RELATED APPLICATIONS

This application claims priority to Taiwan Application Serial Number 112147532, filed Dec. 6, 2023, which is herein incorporated by reference.

### BACKGROUND

### Field of Disclosure

The present disclosure relates to a driving method of a display device, and more particularly to a driving method of a display device for reducing abnormality in a display screen.

### Description of Related Art

Some conventional display devices mainly include a pixel display region and a scan driving circuit. The pixel display region is composed of a plurality of pixel circuits arranged in an array, and each pixel circuit includes a light emitting element (e.g., a light emitting diode). The light emitting element emits brightness required for a display screen according to a driving current flowing through it. During each frame time, the scan driving circuit generates multiple scanning signals and light emitting control signals in a time-division manner to turn on pixel circuits of each column in the pixel display region, so that data information is sequentially written into each pixel circuit in the pixel display region.

However, in common signal lines in the pixel display region, there are inevitably parasitic capacitances and stray capacitances between electrodes, which cause signal coupling effects when data information is written into the pixel circuits, thereby affecting stability of the signals and a light emitting interval of the pixel circuits. Such signal coupling effects cause abnormal phenomena such as flicker, uneven brightness, cross talk, and image sticking in the display screen of the display device.

### SUMMARY

Therefore, the present disclosure provides a driving method of a display device, used for driving at least one pixel circuit in a plurality of columns, in which each of the at least one pixel circuit has at least one light emitting element, and the driving method includes: executing a plurality of driving sequences during a frame time to sequentially drive the at least one pixel circuit in the columns, in which executing each of the driving sequences includes: inputting at least one data pulse signal to write data information into the at least one pixel circuit of a corresponding one of the columns; and inputting a light emitting control pulse signal to the at least one pixel circuit of the corresponding one of the columns, in which the light emitting control pulse signal includes at least one light emitting control pulse within the frame time; in which the at least one data pulse signal and the at least one light emitting control pulse signal in each of the driving sequences are alternately inputted to the at least one pixel circuit of the corresponding columns, so that the at least one pixel circuit in each of the columns does not receive the at least one data pulse signal and the at least one light emitting control pulse at the same time.

According to an embodiment of the present disclosure, the driving sequences comprises a first driving sequence and a second driving sequence, before executing the second driving sequence, the at least one data pulse signal and the at least one light emitting control pulse in the first driving sequence are completely inputted to the at least one pixel circuit of the corresponding one of the columns.

According to an embodiment of the present disclosure, the at least one data pulse signal and the at least one light emitting control pulse in each of the driving sequences are completely inputted within a scanning period, and the scanning period is the time for driving the at least one pixel circuit in one of the columns.

According to an embodiment of the present disclosure, the at least one pixel circuit in the columns further includes a common line electrically connected to the at least one pixel circuit in each of the columns to generate a common signal to the at least one pixel circuit in each of the columns.

According to an embodiment of the present disclosure, the at least one light emitting control pulse and the common signal in each of the driving sequences are alternately inputted to corresponding one of the at least one pixel circuit.

According to an embodiment of the present disclosure, the driving method further includes providing at least one reset signal to the at least one pixel circuit in each of the columns within the frame time through a time pulse signal.

According to an embodiment of the present disclosure, the at least one light emitting control pulse in each of the driving sequences and the at least one data pulse signal in other of the driving sequences are alternately inputted to the corresponding one of the at least one pixel circuit during the frame time.

According to an embodiment of the present disclosure, the at least one light emitting element is a micro light emitting diode.

According to an embodiment of the present disclosure, the light emitting control pulse has a high logic level.

According to an embodiment of the present disclosure, the at least one pixel circuit comprises a plurality of N-type transistors, and the plurality of N-type transistors are turned on based on the high logic level of the light emitting control pulse.

According to an embodiment of the present disclosure, the light emitting control pulse has a low logic level.

According to an embodiment of the present disclosure, the at least one pixel circuit comprises a plurality of P-type transistors, and the plurality of P-type transistors are turned on based on the low logic level of the light emitting control pulse.

According to an embodiment of the present disclosure, supply timings of the at least one data pulse signal and the at least one light emitting control pulse signal are controlled by a timing controller.

According to an embodiment of the present disclosure, in the at least one pixel circuit, a path of a driving current flowing through the at least one light emitting element comprises at least two transistors.

According to an embodiment of the present disclosure, the driving method further comprises providing at least one scanning signal to the at least one pixel circuit in each of the plurality of columns within the frame time.

The present disclosure provides a driving method of a display device, used for driving at least one pixel circuit in a plurality of columns, in which each of the at least one pixel circuit has at least one light emitting element, and the driving method includes: executing a plurality of driving sequences during a frame time to sequentially drive the at least one pixel circuit in the columns, in which executing each of the driving sequences includes: inputting at least one data pulse signal to write data information into the at least one pixel circuit of a corresponding one of the columns; and inputting a light emitting control pulse signal to the at least one pixel circuit of the corresponding one of the columns, in which the light emitting control pulse signal includes at least one light emitting control pulse within the frame time; in which the at least one light emitting control pulse in each of the plurality of driving sequences and the at least one data pulse signal in other of the plurality of driving sequences are alternately inputted to corresponding one of the at least one pixel circuit during the frame time.

### BRIEF DESCRIPTION OF THE DRAWINGS

In order to make the above and other objects, features, advantages and embodiments of the present disclosure easier to understand, the accompanying drawings are described as follows:

FIG. 1 is a schematic diagram of a driving method of a display device according to an embodiment of the present disclosure;

FIG. 2 is a schematic diagram of a pixel circuit applicable to a driving method according to an embodiment of the present disclosure;

FIG. 3 is a waveform diagram of a pixel circuit executing the driving method of FIG. 1;

FIG. 4 shows a schematic diagram when a data pulse signal and a light emitting control pulse of a light emitting control signal overlap each other;

FIG. 5 is a schematic diagram of another pixel circuit applicable to a driving method according to an embodiment of the present disclosure;

FIG. 6 is a waveform diagram of a driving method for controlling the pixel circuit of FIG. 5;

FIG. 7 is a waveform diagram for controlling the pixel circuit of FIG. 5 by using a driving method of the present disclosure;

FIG. 8A shows a schematic diagram of flicker values measured without applying a driving method of the present disclosure; and

FIG. 8B shows a schematic diagram of flicker values measured with applying a driving method of the present disclosure.

### DETAILED DESCRIPTION

The following disclosure provides many different embodiments or examples for implementing different features of the provided disclosure. The embodiments of components and configurations described below are examples only and are not intended to be limiting. In addition, for the purpose of simplification and clarity, the present disclosure repeats reference numerals and/or numbers in each example in the present disclosure, and this repetition does not in itself limit the relationship between various embodiments and/or components discussed.

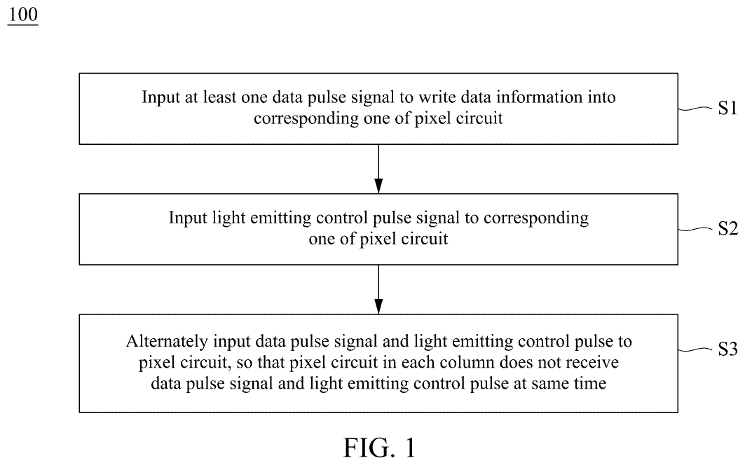

Please refer to FIG. 1, which is a schematic diagram of a driving method 100 of a display device according to an embodiment of the present disclosure. The driving method 100 may be applied to drive various pixel circuits, and a plurality of driving sequences can be executed within one frame time, in which executing each driving sequence includes Steps S1 to S3 to sequentially drive the pixel circuits in each column. In this way, light emitting elements in the pixel circuits can generate corresponding grayscales during each frame time, so that the display device can display images normally.

In all pixel circuits of the display device, there is usually a common line (e.g., a reference voltage or a reset voltage). In order to prevent parasitic capacitive and stray capacitive coupling effects of the common line from affecting picture quality of the display device, main technical features of the driving method 100 are as follows: (1) making a data pulse signal and a light emitting control signal in each driving sequence alternately input to each pixel circuit in a same column; (2) making the light emitting control signal received by the pixel circuit of each column are interleaved with data pulse signals received by pixel circuits of other columns.

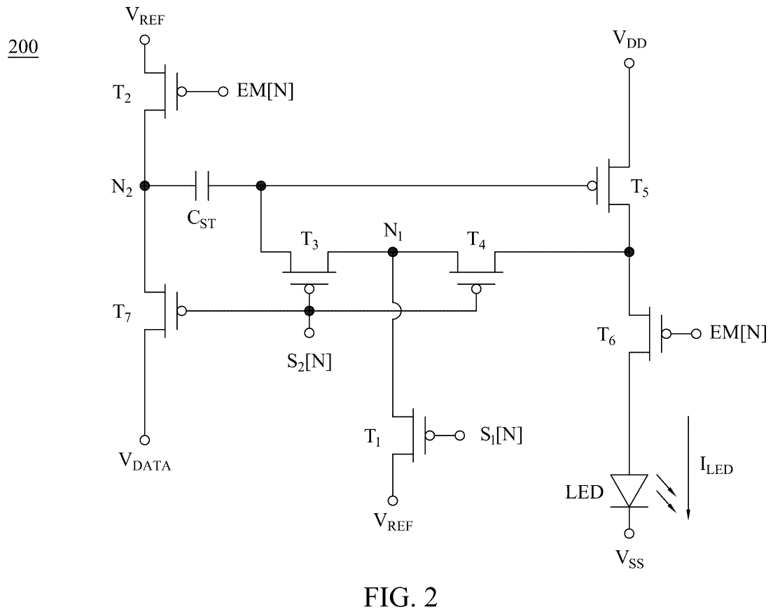

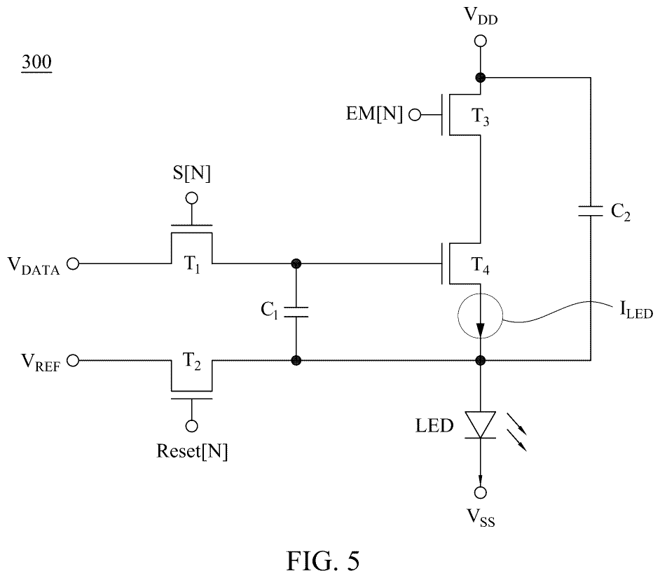

In this way, a light emitting period and a data writing period of each pixel circuit do not overlap with each other, thus avoiding the coupling effects caused by the presence of parasitic capacitance and stray capacitance in the common line when the data pulse signal is written into the pixel circuit. In following examples, the driving method 100 of the present disclosure is explained in conjunction with a pixel circuit 200 of FIG. 2 and a pixel circuit 300 of FIG. 5.

Please refer to FIG. 2. FIG. 2 is a schematic diagram of a pixel circuit 200 applicable to the driving method 100 according to an embodiment of the present disclosure. The pixel circuit 200 includes transistors T₁ to T₇, a light emitting diode LED, and a storage capacitor C_{ST}. The transistor T₅ and the transistor T₆ are driving transistors for providing a driving current I_{LED} to drive the light emitting diode LED to emit light. In embodiments of the present disclosure, the transistors T₁ to T₇ may be P-type transistors (PMOS). The transistors T₁ to T₇ are turned off when control terminals (i.e., gate terminals) receive a high logic level, and the transistors T₁ to T₇ are turned on when the control terminals receive a low logic level. It should be understood that the driving method 100 may also be applied to a pixel circuit in which the transistors T₁ to T₇ are N-type transistors (NMOS). The transistors T₁ to T₇ are turned on when the control terminals receive the high logic level, and the transistors T₁ to T₇ are turned off when the control terminals receive the low logic level.

In an embodiment of the present disclosure, the light emitting diode LED adopts a micro LED (μLED), and the driving method 100 adopts pulse width modulation (PWM) to control light emitting of the light emitting diode LED. Specifically, when the driving method 100 of the present disclosure is used to drive the micro LED, the micro LED is controlled to have a shorter light emitting period, that is, a duty of the light emitting control signal is smaller. In this way, the micro LED may be operated with higher luminous efficiency during a period of larger instantaneous current. In addition, one frame time may have one or more light emitting periods (e.g., only one light emitting control pulse or multiple light emitting control pulses) to drive the micro LED to emit light during the one or more light emitting periods, but the disclosure is not limited thereto.

Please continue to refer to FIG. 2. A first terminal (i.e., source/drain) of the transistor T₆ in the pixel circuit 200 is coupled to the transistor T₅, and a second terminal (i.e., source/drain) of the transistor T₆ is coupled to the light emitting diode LED, and a control terminal of the transistor T₆ receives the light emitting control signal EM[N]. A first terminal of the transistor T₅ receives a power supply voltage V_{DD}, and a second terminal of the transistor T₅ is coupled to the transistor T₆ and the transistor T₄, and a control terminal of the transistor T₅ is coupled to the storage capacitor C_{ST}.

A first terminal of the transistor T₄ is coupled to the transistor T₆ and the transistor T₅, and a second terminal of the transistor T₄ is coupled to the transistor T₃ and the transistor T₁. A first terminal of the transistor T₅ is coupled to the storage capacitor C_{ST} and the control terminal of the transistor T₅, and a second terminal of the transistor T₃ is coupled to the transistor T₄ and the transistor T₁. A first terminal of the transistor T₇ is coupled to the storage capacitor C_{ST} and the transistor T₂, and a second terminal of the transistor T₇ receives the data pulse signal V_{DATA}. Control terminals of the transistors T₃, T₄ and T₇ receive the scanning signal S₂[N].

A first terminal of the transistor T₂ receives a reference signal V_{REF}, and a second terminal of the transistor T₂ is coupled to the transistor T₇ and the storage capacitor C_{ST}, and a control terminal of the transistor T₂ receives the light emitting control signal EM[N]. A first terminal of the transistor T₁ receives the reference signal V_{REF}, and a second terminal of the transistor T₁ is coupled to the transistor T₃ and the transistor T₄, and a control terminal of the transistor T₁ receives the scanning signal S₁[N]. Among them, N represents a number of columns, so EM[N] represents the light emitting control signal of the N^{th} column, and S₁[N] represents a first scanning signal of the N^{th} column, and S₂[N] represents a second scanning signal of the N^{th} column.

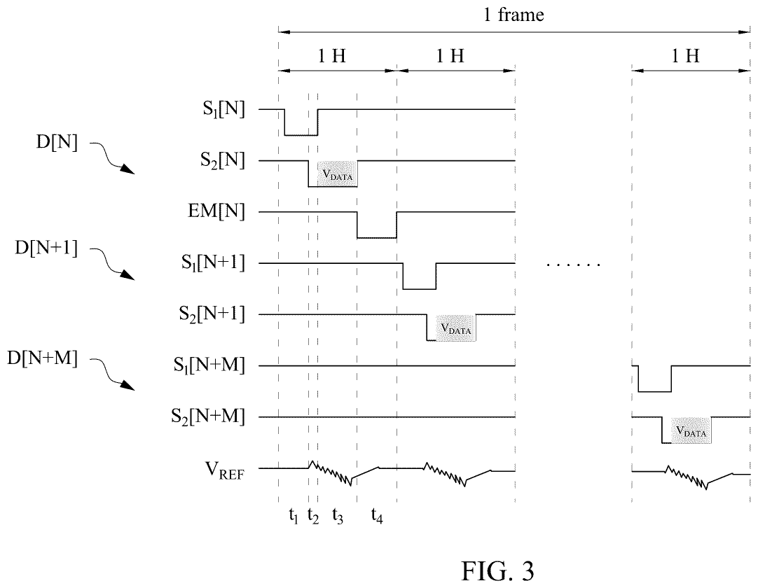

Please refer to FIG. 3, which is a waveform diagram of the pixel circuit 200 executing the driving method 100 of FIG. 1. One frame time includes multiple driving sequences D[N], D[N+1], . . . . D[N+M] to sequentially drive the pixel circuit in each column. Among them, 1H (one horizontal line time) represents the time required to scan a column of pixel circuits. Taking the driving sequence D[N] as an example below, the time to drive the pixel circuit in the N^{th} column can be mainly divided into four intervals t₁, t₂, t₃ and t₄, and some detailed operating principles are well known to those skilled in the art, so it will not be described in detail here.

Please refer to FIGS. 2 and 3. In the interval t₁, the scanning signal S₁[N] is at a low voltage level (equivalent to a low logic level). The scanning signal S₂[N] is at a high voltage level (equivalent to a high logic level). The light emitting control signal EM[N] is at a high voltage level. Therefore, the transistor T₁ is turned on according to the low voltage level to transmit the reference signal V_{REF} to a node N₁, and the transistors T₂ to T₇ are turned off according to the high voltage levels.

In the interval t₂, the scanning signal S₁[N] is at a low voltage level (equivalent to the low logic level), and the scanning signal S₂[N] is at the low voltage level (equivalent to the low logic level), and the light emitting control signal EM[N] is at a high voltage level (equivalent to the high logic level), so that the transistors T₁, T₃, T₄ and T₇ are turned on according to the low voltage levels, and the transistors T₂ and T₆ are turned off according to the high voltage level. The conduction of the transistor T₇ causes the data pulse signal V_{DATA} to be inputted to a node N₂, which is the first terminal (i.e., the electrode) of the storage capacitor C_{ST}. The second terminal (i.e., the electrode) of the storage capacitor C_{ST} receives the reference signal V_{REF} with the same potential as the node N₁ due to the conduction of the transistor T₃ and the transistor T₄, so that the control terminal of the transistor T₅ is turned on according to the reference signal V_{REF}.

The interval t₃ is a writing period of the data pulse signal V_{DATA} of the pixel circuit 200, in which the scanning signal S₁[N] is at a high voltage level, and the scanning signal S₂[N] is at a low voltage level, and the light emitting control signal EM[N] is at a high voltage level, which causes the transistor T₃, T₄ and T₇ to be turned on according to the low voltage level, while the transistor T₁, T₂ and T₆ are turned off according to the high voltage levels. The conduction of the transistor T₇ maintains the potential of the first terminal (node N₁) of the storage capacitor C_{ST} at the data pulse signal V_{DATA}, and the potential of the second terminal of the storage capacitor C_{ST} is maintained at V_{DD}−Vₜₕ₅, so that the transistor T₅ can continue to be turned on in the interval t₃. Therefore, the voltage difference across the storage capacitor C_{ST} is (V_{DD}−Vₜₕ₅)−V_{DATA}.

In the interval t₄, the scanning signal S₁[N] is at a high voltage level, and the scanning signal S₂[N] is at a high voltage level, and the light emitting control signal EM[N] is at a low voltage level, so that the transistor T₂ and the transistor T₆ are turned on according to the low voltage level, and the transistor T₁, the transistor T₃, the transistor T₄ and the transistor T₇ are turned off according to the high voltage levels. The conduction of transistor T₂ causes the first terminal (node N₂) of the storage capacitor C_{ST} to receive the reference signal V_{REF}, and the potential of the second terminal of the storage capacitor C_{ST} is (V_{DD}−Vₜₕ₅)−V_{DATA}+V_{REF}, so the transistor T₅ can continue to be turned on in the interval t₄. The conduction of the transistor T₆ enables the driving current I_{LED} to flow through to the light emitting diode LED, and controls the light emitting diode LED to emit a required brightness. Among them, the driving current I_{LED} can be obtained by Equation (1):

$${I}_{L E D} = \frac{1}{2} K ( {V}_{S G} - {V}_{th 5} ) = \frac{1}{2} {K ( {V}_{DATA} - {V}_{REF} )}^{2} \qquad Equation ( 1 )$$

Among them, Vₜₕ₅ is a critical voltage value of transistor T₅. Equation (1) is a calculation formula for the driving current I_{LED}, and is known to those skilled in the art, so it will not be described detail herein.

Please continue to refer to FIG. 2 and FIG. 3. Through the driving method 100 of the present disclosure, the data pulse signal V_{DATA} and the light emitting control signal EM[N] in the driving sequence D[N] are alternately inputted to the pixel circuit 200, and the light emitting control signal EM[N] also avoids overlapping with the input timings of the data pulse signals V_{DATA} in other driving sequences D[N+1], D[N+2], . . . . D[N+M]. In the same way, in the corresponding driving sequences D[N+1], D[N+2], . . . . D[N+M] of the pixel circuit in other columns (the (N+1)th column, the (N+2)th column, . . . , and the (N+M)th column), the data pulse signal V_{DATA} and the corresponding light emitting control signals EM[N+1], EM[N+2], . . . . EM[N+M] are also alternately inputted to the pixel circuit of each column, and the light emitting control signal also avoids overlapping with the input timings of the data pulse signals V_{DATA} in other driving sequences.

As such, it is possible to prevent the signal jitter of the common line (reference signal V_{REF}) from affecting the light emitting period of each pixel circuit during the writing of the data pulse signal V_{DATA} in each driving sequences, and solve the abnormal phenomena such as flicker, uneven brightness, cross talk, or image sticking in the screen of the display device caused by the capacitive coupling effects. Although not shown in the figures, in some embodiments, the driving method 100 further includes providing at least one reset signal to the pixel circuit in each column through a time pulse signal. Among them, the supply timings of the time pulse signal, the data pulse signal, the light emitting control signal, and the reset signal can be controlled through a timing controller.

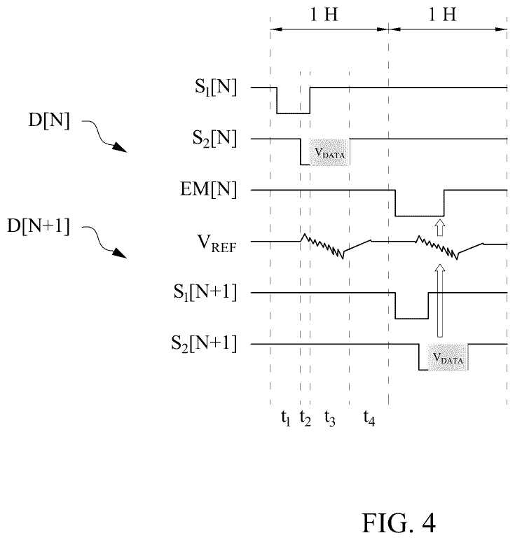

Please refer to FIG. 4, which is a schematic diagram when the data pulse signal and the light emitting control pulse of the light emitting control signal overlap each other. As shown in the FIG. 4, the light emitting control signal EM[N] of the driving sequence D[N] is not completed during the 1H period, but is inputted to the pixel circuit 200 to drive the light emitting diode LED therein during the driving sequence D[N+1] that drives the pixel circuit of the (N+1)^{th} column. Therefore, the writing period of the data pulse signal V_{DATA} in the driving sequence D[N+1] overlaps with the light emitting control signal EM[N] in the driving sequence D[N], so that the signal jitter caused by the capacitive coupling effects on the common line (the reference signal V_{REF}) affects the light emitting period of the pixel circuit 200 in the driving sequence D[N], thereby causing abnormal phenomena such as flicker, uneven brightness, cross talk, or image sticking in the display screen of the display device.

Please refer to FIG. 5, which is a schematic diagram of another pixel circuit 300 applicable to the driving method 100 according to an embodiment of the present disclosure. The pixel circuit 300 includes transistors T₁ to T₄, a light emitting diode LED, capacitors C₁ and C₂. In the embodiment of FIG. 5, the light emitting diode LED adopts a micro LED, and the transistors T₁ to T₄ are N-type transistors (NMOS). When control terminals of the transistors T₁ to T₄ receive a low logic level, those are turned off, and when those receive a high logic level, those are turned on. It should be understood that the driving method 100 may also be applied to the pixel circuit in which the transistors T₁ to T₄ in FIG. 5 are changed to P-type transistors (PMOS). When the control terminals of the transistors T₁ to T₄ receive a low logic level, those are turned on, and when those receive a high logic level, those are turned off.

Since FIG. 5 clearly depicts the circuit structure of the pixel circuit 300, those skilled in the art can understand the electrical connection relationship between various electronic components (e.g., the transistors T₁ to T₄, light emitting diode LED, capacitors C₁ and C₂) in the pixel circuit 300. Therefore, the following mainly explains the purpose and effect that the driving method 100 of the present disclosure can achieve compared with another driving method based on the sequence diagram.

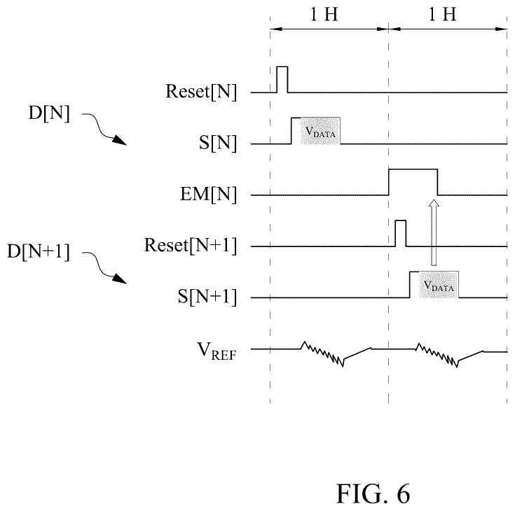

Please refer to FIG. 6, which is a waveform diagram of a driving method controlling the pixel circuit 300 of FIG. 5. Among them, the light emitting control signal EM[N] of the driving sequence D[N] is not completed during the 1H period, but is input to the pixel circuit 300 to drive the light emitting diode LED therein during the driving sequence D[N+1] that drives the pixel circuit of the (N+1)^{th} column. As a result, the writing period of the data pulse signal V_{DATA} in the driving sequence D[N+1] overlaps with the light emitting control signal EM[N] in the driving sequence D[N], so that the signal jitter caused by the capacitive coupling effects on the common line (reference signal V_{REF}) affects the light emitting period of the pixel circuit 300 in the driving sequence D[N], thereby causing abnormal phenomena such as flicker, uneven brightness, cross talk, or image sticking in the display screen of the display device.

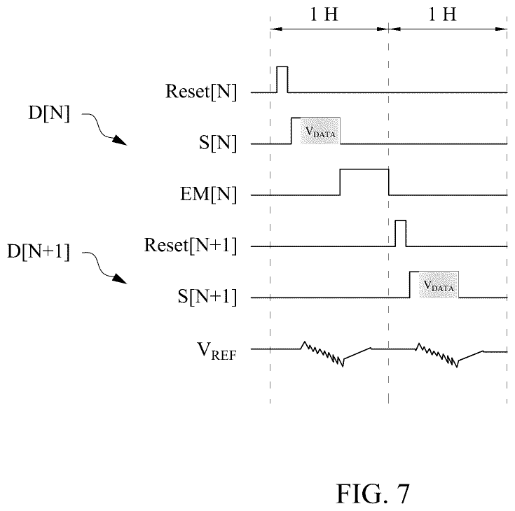

Please refer to FIG. 7, which is a waveform diagram for controlling the pixel circuit 300 of FIG. 5 using the driving method 100 of the present disclosure. Among them, the data pulse signal V_{DATA} and the light emitting control signal EM[N] in the driving sequence D[N] are alternately inputted to the pixel circuit 300, and the light emitting control signal EM[N] also avoids overlapping with the input timings of the data pulse signal V_{DATA} in the driving sequence D[N+1]. Similarly, in the driving sequence D[N+1] corresponding to the pixel circuit of the (N+1)^{th} column, the data pulse signal V_{DATA} and the corresponding light emitting control signal EM[N+1] are alternately inputted to the pixel circuit of the (N+1)^{th} column, and the light emitting control signal EM[N+1] also avoids overlapping with the input timings of the data pulse signals V_{DATA} in other driving sequences (e.g., D[N+2], D[N+3], . . . . D[N+M]). As such, it is possible to prevent the signal jitter caused by the common line (reference signal V_{REF}) from affecting the light emitting period of each pixel circuit during the writing of the data pulse signal V_{DATA} in each driving sequences, and solve the abnormal phenomena such as flicker, uneven brightness, cross talk, or image sticking in the screen of the display device caused by the capacity coupling effects.

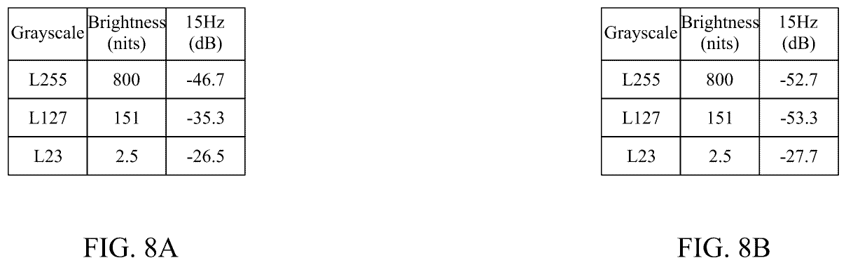

Please refer to FIGS. 8A and 8B. FIG. 8A shows a schematic diagram of flicker values measured without applying the driving method 100 of the present disclosure. FIG. 8B shows a schematic diagram of flicker values measured with applying the driving method 100 of the present disclosure. As shown in FIGS. 8A and 8B, under the conditions of the same grayscale (L255), brightness (800 nits) and frequency (15 Hz), the flicker value (brightness change per frequency in dB) in FIG. 8A is −46.7 dB, which is greater than the flicker value −52.7 dB measured by applying the driving method 100 of the present disclosure in FIG. 8B.

Under the conditions of the same grayscale (L127), brightness (151 nits) and frequency (15 Hz), the flicker value in FIG. 8A is −35.3 dB, which is greater than the flicker value −53.3 dB in FIG. 8B measured by applying the driving method 100 of the present disclosure. Under the conditions of the same grayscale (L23), brightness (2.5 nits) and frequency (15 Hz), the flicker value in FIG. 8A is −26.5 dB, which is greater than the flicker value −27.7 dB in FIG. 8B measured by applying the driving method 100 of the present disclosure. It should be understood that under other measurement conditions of grayscale, brightness and frequency, the advantages of the driving method 100 in reducing the flicker value compared to other driving methods can also be demonstrated. In this way, applying the driving method 100 of the present disclosure can effectively reduce a flicker rate of the display device, so that the display screen is less likely to have various mura phenomena.

According to the driving method of the display device of the present disclosure, the data pulse signal and the light emitting control signal in each driving sequence are alternately inputted to each pixel circuit in the same column, and the light emitting control signal received by the pixel circuit of each column is interleaved with the data pulse signals received by the pixel circuits of other columns, which can effectively prevent the signal jitter of the common line when the data pulse signal is written into the pixel circuit, and thus does not affect the light emitting period of each pixel circuit. In this way, through the driving method of the display device of the present disclosure, abnormal phenomena such as flicker, uneven brightness, cross talk, or image sticking in the display screen caused by the capacitive coupling effects can be solved.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. A driving method of a display device, used for driving at least one pixel circuit in a plurality of columns, wherein each of the at least one pixel circuit has at least one light emitting element, and the driving method comprises:
executing a plurality of driving sequences during a frame time to sequentially drive the at least one pixel circuit in the plurality of columns, wherein executing each of the plurality of driving sequences comprises:
inputting at least one data pulse signal to write data information into the at least one pixel circuit of a corresponding one of the plurality of columns; and
inputting a light emitting control pulse signal to the at least one pixel circuit of the corresponding one of the plurality of columns, wherein the light emitting control pulse signal comprises at least one light emitting control pulse within the frame time;
wherein the at least one data pulse signal and the at least one light emitting control pulse signal in each of the plurality of driving sequences are alternately inputted to the at least one pixel circuit of the corresponding one of the plurality of columns, so that the at least one pixel circuit in each of the plurality of columns does not receive the at least one data pulse signal and the at least one light emitting control pulse at the same time.

2. The driving method of claim 1, wherein the plurality of driving sequences comprises a first driving sequence and a second driving sequence, before executing the second driving sequence, the at least one data pulse signal and the at least one light emitting control pulse in the first driving sequence are completely inputted to the at least one pixel circuit of the corresponding one of the plurality of columns.

3. The driving method of claim 1, wherein the at least one data pulse signal and the at least one light emitting control pulse in each of the plurality of driving sequences are completely inputted within a scanning period, and wherein the scanning period is the time for driving the at least one pixel circuit in one of the plurality of columns.

4. The driving method of claim 1, wherein the at least one pixel circuit in the plurality of columns further comprises a common line electrically connected to the at least one pixel circuit in each of the plurality of columns to generate a common signal to the at least one pixel circuit in each of the plurality of columns.

5. The driving method of claim 4, wherein the at least one light emitting control pulse and the common signal in each of the plurality of driving sequences are alternately inputted to corresponding one of the at least one pixel circuit.

6. The driving method of claim 1, further comprising:
providing at least one reset signal to the at least one pixel circuit in each of the plurality of columns within the frame time through a time pulse signal.

7. The driving method of claim 1, wherein the at least one light emitting control pulse in each of the plurality of driving sequences and the at least one data pulse signal in other of the plurality of driving sequences are alternately inputted to corresponding one of the at least one pixel circuit during the frame time.

8. The driving method of claim 1, wherein the at least one light emitting element is a micro light emitting diode.

9. The driving method of claim 1, wherein the at least one light emitting control pulse has a high logic level.

10. The driving method of claim 9, wherein the at least one pixel circuit comprises a plurality of N-type transistors, and the plurality of N-type transistors are turned on based on the high logic level of the at least one light emitting control pulse.

11. The driving method of claim 1, wherein the at least one light emitting control pulse has a low logic level.

12. The driving method of claim 11, wherein the at least one pixel circuit comprises a plurality of P-type transistors, and the plurality of P-type transistors are turned on based on the low logic level of the at least one light emitting control pulse.

13. The driving method of claim 1, wherein supply timings of the at least one data pulse signal and the at least one light emitting control pulse signal are controlled by a timing controller.

14. The driving method of claim 1, wherein in the at least one pixel circuit, a path of a driving current flowing through the at least one light emitting element comprises at least two transistors.

15. The driving method of claim 1, further comprising:
providing at least one scanning signal to the at least one pixel circuit in each of the plurality of columns within the frame time.

16. A driving method of a display device, used for driving at least one pixel circuit in a plurality of columns, wherein each of the at least one pixel circuit has at least one light emitting element, and the driving method comprises:
executing a plurality of driving sequences during a frame time to sequentially drive the at least one pixel circuit in the plurality of columns, wherein executing each of the plurality of driving sequences comprises:
inputting at least one data pulse signal to write data information into the at least one pixel circuit of a corresponding one of the plurality of columns; and
inputting a light emitting control pulse signal to the at least one pixel circuit of the corresponding one of the plurality of columns, wherein the light emitting control pulse signal comprises at least one light emitting control pulse within the frame time;
wherein the at least one light emitting control pulse in each of the plurality of driving sequences and the at least one data pulse signal in other of the plurality of driving sequences are alternately inputted to corresponding one of the at least one pixel circuit during the frame time.
